(19) United States
(12) Patent Application Publication
(10) Pub. No.: US 2007/0137120 A1
(43) Pub. Date: Jun. 21, 2007

(54) Cladding for door and window frames

(76) Inventor: Christopher Raymond, Webster, PA (US)

Correspondence Address: FLOYD B. CAROTHERS;CAROTHERS AND CAROTHERS, 445 FORT PITT BOULEVARD, SUITE 500, PITTSBURGH, PA, 15219, US

(21) Appl. No.: 11/303,280

(22) Filed: Dec. 16, 2005

(51) Int. Cl. E06B 1/04

(52) U.S. Cl. 52/211

(57) ABSTRACT

A two-piece cladding system for covering a door or window frame. The cladding is constructed of sheet aluminum and includes a fascia strip which covers the fascia portion and inner and outer edges of brick mold surrounding the frame and further includes an out-turned inner lip for covering a portion of the reveal provided between the brick mold and the door frame. The second portion of the cladding includes a channel strip also constructed of sheet aluminum which has a face and outer flanges which are dimensioned for covering the door jambs and header jamb with the flanges respectively engaging inner surfaces of the jambs and the outer reveal under compression with the out-turned lip of the fascia strip retained underneath the outer flange whereby the two-piece cladding is retained on the frame assembly without the requirement of fasteners.

### FIELD OF THE INVENTION

This invention relates generally to cladding for door and window frames, and more particularly to prefabricated cladding system components for cladding the outside surfaces of a door or window frame with trim.

### BACKGROUND OF THE INVENTION

Door and window frames are usually constructed of wood or metal and their exterior surfaces periodically require refinishing as by painting or varnishing. In order to avoid the requirement for refinishing or repainting, it has become a common practice to retrofit the doorframe or window frame and trim molding with a protective cladding manufactured of aluminum or plastic. For example, see the plastic cladding disclosed in U.S. Pat. No. 5,669,192.

However, the problem incurred with most present day cladding systems for retrofit application is that nail or screw connectors must be utilized to secure the cladding to the exposed doorframe and trim, which is unsightly. Also, the prior art cladding systems are not readily adjustable to compensate for slight variations in dimension of the combined exposed doorframe and exterior mold assembly.

### SUMMARY OF THE INVENTION

The cladding system of the present invention is a two-piece system which is highly adjustable for conforming to slight differences in dimension and spacing for use with a door or window frame assembly including exterior molding. Such frame assemblies generally include opposed side jambs and a header with exterior brick molding covering an external perimeter portion of the outer surfaces of the doorframe thereby leaving an inner reveal portion of the outer surfaces of the doorframe. The two-piece cladding system is constructed of sheet aluminum and includes a fascia strip dimensioned and contoured for covering the fascia portion and inner and outer edges of the brick mold. This fascia strip further includes an out-turned inner lip for covering a portion of the exposed reveal of the fascia portion of the doorframe.

The second portion of the cladding system includes an aluminum channel strip having a face and inner and outer flanges dimensioned and contoured for covering the jambs and header with the flanges thereof respectively engaging the inner surface and the reveal of the jamb under compression, with the out-turned lip of the fascia strip retained under the outer flange of this channel. The two-piece cladding system is thus retained in place on the frame assembly without fasteners. In addition, this overlap connection between the two portions of the cladding is relatively inconspicuous.

In usual fashion, conventional weather strip is secured over the inner flange of the channel strip to provide a tight weather seal for the door or window.

The result is the provision of a two-piece adjustable cladding system which readily conforms to slight variations in dimension in the doorframe assembly, such as the extent of the reveal on the outer portions of the doorframe, and which additionally is easily mounted without the requirement of unsightly fasteners.

### BRIEF DESCRIPTION OF THE DRAWINGS

Other objects and advantages appear hereinafter in the following description and claims. The accompanying drawings show, for the purpose of exemplification, without limiting the invention or appended claims, certain practical embodiments of the present invention wherein:

FIG. 1 is a front elevation view of a door and a frame with cladding according to the invention installed over the frame assembly;

FIG. 2 is a fragmentary isometric view of the upper left corner of the doorframe and cladding of FIG. 1;

FIG. 3 is a view in cross section of the door frame and cladding taken along section line III-III of FIG. 2; and

FIG. 4 is an isometric view of a portion of the channel strip portion of the cladding system of the present invention prior to application to a doorframe.

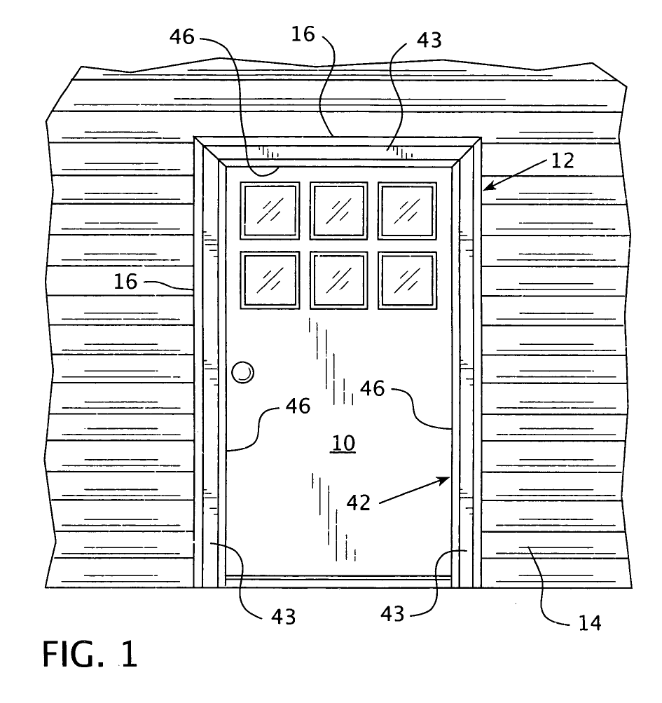

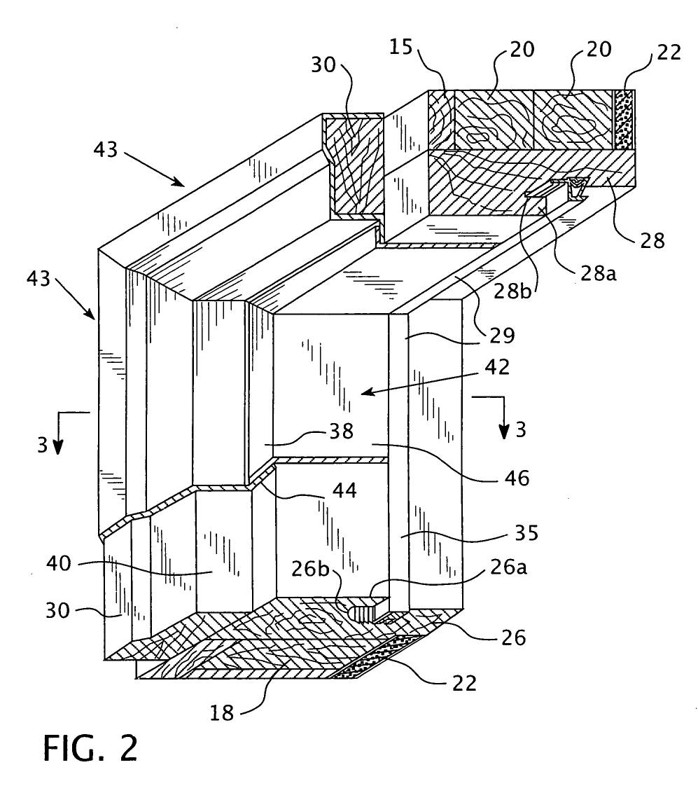

### DESCRIPTION OF THE PREFERRED EMBODIMENT

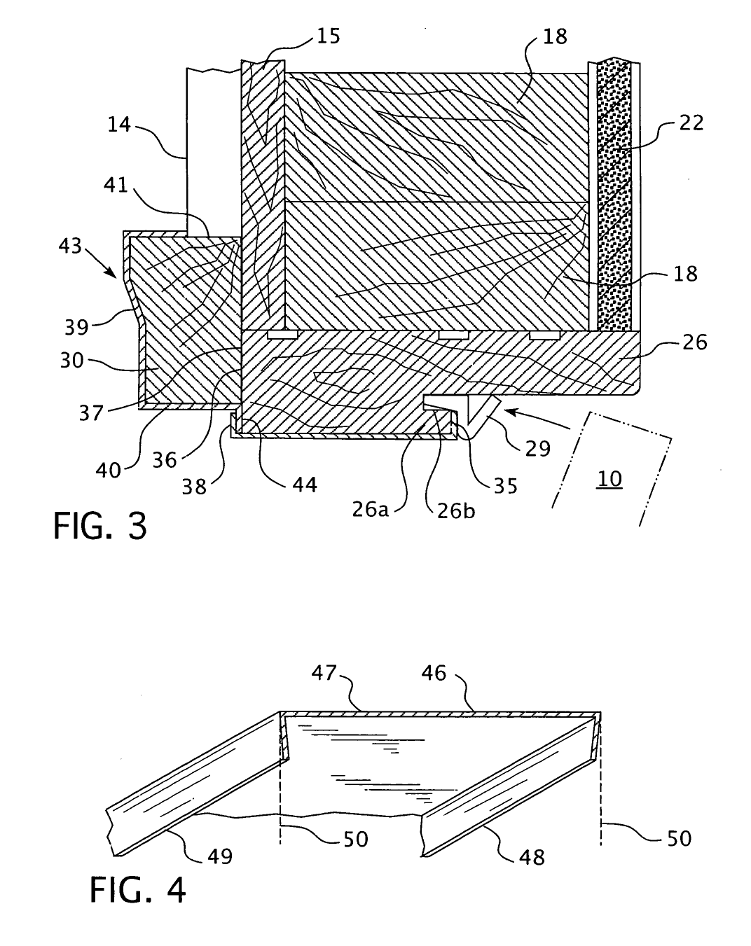

Referring to the drawings, a door 10 is hung in a standard doorframe, indicated generally by the number 12, with siding 14 held in place on exterior sheeting 15 (FIG. 3) adjacent to the outer perimeter 16 of the frame.

Doorframe 12 is mounted in an opening formed of a pair of trimmer studs 18 on opposite sides (only one side being shown) and a header 20 between interior wall board 22 and exterior sheeting 15. The frame includes a pair of side jambs 26 fixed next to respective ones of studs 18, and a header jamb 28 fixed next to header 20. Jambs 26 and 28 are equal in width to the thickness of the wall between the inner and outer surfaces of wall board 22 and sheeting 15, respectively. Door stops 26a and 28a are integrally formed along the entire inner perimeter of the jambs to provide an inner jamb surface 35 and include kerfs 26b and 28b retaining a resilient weather stripping 29 for positively sealing the door opening when the door 10 is closed. Doorframe 12 further includes exterior trim or brick mold 30 which extends along the exterior edges of jambs 26 and 28 and bridges between the exterior edges 16 and adjacent exterior edge portions of siding 14.

The two-piece cladding system of the present invention is provided to cover the frame assembly which includes the door jambs 26 and the header jamb 28 which each have inner surfaces 35 and outer surfaces 36. The frame assembly also includes the brick mold 30 covering an external perimeter portion 37 of outer surfaces 35 thereby leaving an inner reveal portion 38 of outer surfaces 36. Brick mold 30 further includes a fascia portion 39 and inner and outer edges 40 and 41 respectively.

The two-piece cladding system 42 of the present invention, for covering the afore described frame assembly is comprised first of all a fascia strip 43 dimensioned and contoured for covering the fascia portions 39 and inner and outer edges 40 and 41 of brick mold 30, and further includes and out-turned inner lip 44 for covering a portion of the reveal 38. The outer flange of fascia strip 43 which covers outer edge 41 is scribed and cut to fit the contours of siding 14.

The two-piece cladding system 42 further includes a second piece which is in the form of a channel strip 46 having a face 47 and inner and outer flanges 48 and 49 respectively dimensioned and contoured for covering the jambs 26 and the headerjamb 28 with the flanges 48 and 49 respectively engaging the inner surface 35 and the reveal 38 under compression, and with the out-turned lip 44 of fascia strip 43 retained under outer flange 38 whereby the two-piece cladding system 42 is retained on the frame assembly without fasteners.

To more readily understand this feature, reference is made to FIG. 4 wherein the channel strip 46 is illustrated alone and it will be recognized that when the channel strip 47 was formed, the inner and outer flanges 48 and 49 were formed with a slight over crimp whereby they extend inwardly toward each other slightly beyond the 90° mark indicated at 50. This permits the inner and outer flanges 48 and 49 to grip the inner surface 35 of the side jambs 26 and the header jamb 28, and the reveal 38 of the respective jambs under compression with the out-turned lip 44 of fascia strip 43 retained under the outer flange 49 whereby the two-piece cladding system 42 is retained on the frame assembly without fasteners.

I claim:

1. A cladding system for use with a frame assembly having two opposed side jambs and a header jamb, the jambs having inner and outer surfaces, the frame assembly also including brick mold covering an external perimeter portion of said outer surfaces thereby leaving an inner reveal portion of said outer surfaces and having a fascia portion and inner and outer edges, a two-piece cladding for covering said frame assembly, comprising:
a fascia strip dimensioned and contoured for covering said fascia portion and inner and outer edges of said brick mold, and including an out-turned inner lip for covering a portion of said reveal; and
a channel strip having a face and inner and outer flanges dimensioned and contoured for covering said jambs with said flanges respectively engaging said inner surface and said reveal under compression with said out-turned lip of said fascia strip retained under said outer flange whereby said two-piece cladding is retained on said frame assembly without fasteners.

2. The cladding system of claim 1, including a weather strip secured over said inner flange of said channel strip.

3. The cladding system of claim 1, wherein said fascia strip and said channel strip are sheet aluminum.
